(19) United States
(12) Patent Application Publication
(10) Pub. No.: US 2026/0304171 A1
(43) Pub. Date: Oct. 1, 2026

(54) MEASUREMENT PARAMETER CONFIGURATION METHOD AND APPARATUS, AND COMPUTER-READABLE STORAGE MEDIUM

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/489,784

(22) PCT Filed: Jun. 5, 2023
(86) PCT No.: PCT/CN2023/098400

§ 371 Date: Dec. 3, 2025

(51) Int. Cl. H04W 24/08

(52) U.S. Cl. CPC H04W 24/08

(57) ABSTRACT

Embodiments of the present disclosure relate to the technical field of communications. Disclosed are a measurement parameter configuration method and apparatus, and a computer-readable storage medium. The measurement parameter configuration method applied to a user terminal (UE) side involves determining a measurement parameter based on the UE's height information. According to the embodiments of the present disclosure, the measurement parameter is determined based on the UE's height information, thereby better meeting the measurement parameter configuration requirements.

### CROSS-REFERENCE TO RELATED APPLICATIONS

This application is a national stage of International Application No. PCT/CN2023/098400, filed on Jun. 5, 2023, which is hereby incorporated by reference in its entirety.

### TECHNICAL FIELD

The present disclosure relates to the field of communication technologies, and in particular, to a measurement parameter configuration method and apparatus, and a computer-readable storage medium.

### BACKGROUND

In recent years, there has been a dramatic surge in global interest in services based on Uncrewed Aerial Vehicles (UAVs), including various UAV operations, personal entertainment of flight experience, and cargo delivery.

In a new radio (NR) system, applications applicable to UAVs are more diversified, and terminals of UAVs are required to have lower latency and transmission rate. Therefore, NR UAVs need to be enhanced based on long term evolution (LTE) UAVs.

### SUMMARY

Embodiments of the present disclosure provide a measurement parameter configuration method and apparatus, and a computer-readable storage medium.

According to a first aspect of the embodiments of the present disclosure, a measurement parameter configuration method is provided, where the method is performed by a user equipment (UE), and includes: determining a parameter for measurement based on height information of the UE.

According to a second aspect of the embodiments of the present disclosure, a measurement parameter configuration method is provided, where the method is performed by a network device, and includes: sending configuration information to a user equipment (UE), where the configuration information is configured to configure a measurement parameter.

According to a third aspect of the embodiments of the present disclosure, a measurement parameter configuration apparatus is provided, where the apparatus is applied to a user equipment (UE), and includes:
an executing unit, configured to determine a parameter for measurement based on height information of the UE.

According to a fourth aspect of the embodiments of the present disclosure, a measurement parameter configuration apparatus is provided, where the apparatus is applied to a network device, and includes: a second communication unit, configured to send configuration information to a user equipment (UE), where the configuration information is configured to configure a measurement parameter.

According to a fifth aspect of the embodiments of the present disclosure, a communication device is provided, including: a transceiver; one or more processors; and a memory storing a computer-executable instruction; where the one or more processors are connected to the transceiver and the memory respectively, and are configured to load and execute the computer-executable instruction to implement the method according to the first aspect or the second aspect.

According to a sixth aspect of the embodiments of the present disclosure, a communication system is provided, including a user equipment and a network device, where the user equipment is configured to perform the method according to the first aspect, and the network device is configured to perform the method according to the second aspect.

According to a seventh aspect of the embodiments of the present disclosure, a computer-readable storage medium is provided, where the computer-readable storage medium stores an executable instruction, the executable instruction is loaded and executed by one or more processors to implement the method according to the first aspect or the second aspect.

The technical solutions provided by the embodiments of the present disclosure may include following beneficial effects.

The parameter for measurement is determined based on the height information of the UE, such that measurement parameter configuration requirements can be better met.

It shall be noted that the above general description and the following detailed description are examples and explanatory only and are not restrictive of the present disclosure.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a schematic structural diagram of a wireless communication system according to an example embodiment.

FIG. 2 is a schematic process diagram of wireless resource management measurement according to an example embodiment.

FIG. 3 is a first flowchart of a measurement parameter configuration method according to an example embodiment.

FIG. 4 is a second flowchart of a measurement parameter configuration method according to an example embodiment.

FIG. 5 is a third flowchart of a measurement parameter configuration method according to an example embodiment.

FIG. 6 is a first block diagram of a measurement parameter configuration apparatus according to an example embodiment.

FIG. 7 is a second block diagram of a measurement parameter configuration apparatus according to an example embodiment.

FIG. 8 is a block diagram of a device 800 for implementing measurement parameter configuration according to an example embodiment.

FIG. 9 is a block diagram of a device 900 for implementing measurement parameter configuration according to an example embodiment.

### DETAILED DESCRIPTION

The embodiments of the present disclosure are described in detail below, and examples of the embodiments are shown in the accompanying drawings, where the same or similar reference numerals represent the same or similar elements or elements having the same or similar functions throughout. The embodiments described below with reference to the accompanying drawings are examples, and are only used to explain the present disclosure, and cannot be construed as a limitation of the present disclosure.

When the following description refers to the drawings, unless otherwise indicated, the same numerals in different drawings indicate the same or similar elements. The implementations set forth in the following description of example embodiments do not represent all implementations consistent with the embodiments of the present disclosure. Instead, they are merely examples of apparatuses and methods consistent with aspects related to the embodiments of the present disclosure as recited in the appended claims.

It will be understood by those skilled in the art that the singular forms “a”, “an”, “the” and “said” used herein may include plural forms as well, unless otherwise specified. It will be further understood that the terms “include” and/or “comprise”, when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may also be present. Furthermore, “connected” or “coupled” as used herein may include wirelessly connected or wirelessly coupled. The term “and/or” used herein includes all or any unit and all combinations of one or more associated listed items.

It should also be understood that although the terms “first”, “second”, “third”, etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on the context, the word “if” and “in case of” as used herein may be interpreted as “when” or “upon” or “in response to determining”.

In the description of the present disclosure, unless otherwise specified, “a plurality of” refers to two or more, and other quantifiers are similar thereto; “at least one of the following items (pieces)”, “one item (piece) or multiple items (pieces)” or similar expressions thereof refers to any combination of these items (pieces), including any combination of a single item (piece) or a plurality of items (pieces). For example, one or more of a, b, or c may represent: a, b, c, a and b, a and c, b and c, or a and b and c, where a, b, and c may be singular or plural; and “and/or” is an association relationship describing associated objects and represents that there may be three relationships, for example, A and/or B may represent three cases: A exists alone, both A and B exist, and B exists alone, where A and B may be singular or plural.

Although the operations are described in a specific order in the drawings in the embodiments of the present disclosure, they should not be understood as requiring these operations to be performed in the specific order shown or in a serial order, or requiring all the operations shown to be performed to obtain a desired result. In certain circumstances, multitasking and parallel processing may be advantageous. In addition, it is also advantageous to send multiple pieces of information through the same message.

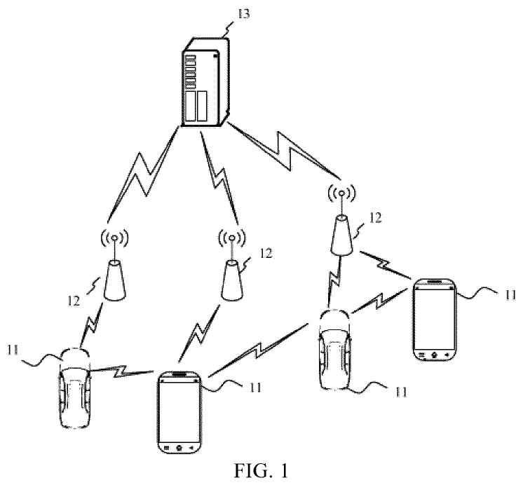

Referring to FIG. 1, FIG. 1 is a schematic structural diagram of a wireless communication system according to an embodiment of the present disclosure. As shown in FIG. 1, the wireless communication system is a communication system based on a cellular mobile communication technology, and the wireless communication system may include: several terminals 11 and several base stations 12.

The terminal 11 may include a device that provides voice and/or data connectivity to a user. The terminal 11 may communicate with one or more core networks through a radio access network (RAN), and the terminal 11 may be Internet of Things terminal, such as a sensor device, a mobile phone (or referred to as a “cellular” phone), and a computer having Internet of Things terminal, for example, may be a fixed, portable, pocket-sized, handheld, computer built-in, or vehicle-mounted apparatus. For example, a station (STA), a subscriber unit, a subscriber station, a mobile station, a mobile, a remote station, an access point, a remote terminal, an access terminal, a user device (user terminal), a user agent, or user equipment (UE). Alternatively, the terminal 11 may include a device of an unmanned aerial vehicle. Alternatively, the terminal 11 may include a vehicle-mounted device, for example, may be a vehicle computer having a wireless communication function, or a wireless communication device externally connected to a vehicle computer. Alternatively, the terminal 11 may include a roadside device, for example, a street lamp, a signal light, or another roadside device that has a wireless communication function.

The base station 12 may be a network device in a wireless communication system. The wireless communication system may be a fourth generation mobile communication (4G) system, also referred to as a long term evolution (LTE) system; or the wireless communication system may be a 5G system, also referred to as a new radio (NR) system or a 5G NR system. Alternatively, the wireless communications system may include still another next generation system of the 5G system. The access network in the 5G system may be referred to as a NG-RAN (New Generation-Radio Access Network), or a machine-type communication system.

The base station 12 may include an evolved base station (eNB) used in a 4G system. Alternatively, the base station 12 may include a base station (gNB) that uses a centralized and distributed architecture in a 5G system. When the base station 12 uses a centralized and distributed architecture, the base station 12 usually includes a central unit (CU) and at least two distributed units (DU). A protocol stack of a packet data convergence protocol (PDCP) layer, a radio link control (RLC) protocol layer, and a media access control (MAC) layer is disposed in the central unit, a protocol stack of a physical (PHY) layer is disposed in the distributed unit, and a specific implementation of the base station 12 is not limited in the embodiments of the present disclosure.

A wireless connection may be established between the base station 12 and the terminal 11 through a wireless air interface. In different implementations, the wireless air interface is a wireless air interface based on a 4th generation mobile communication network technology (4G) standard; or the wireless air interface is a wireless air interface based on a 5th generation mobile communication network technology (5G) standard, for example, the wireless air interface is a new air interface; or the wireless air interface may be a wireless air interface based on a 5th generation mobile communications network technology standard.

In some embodiments, an E2E (End to End) connection may be further established between the terminals 11. For example, a scenario such as vehicle-to-vehicle (V2V) communication, vehicle-to-infrastructure (V2I) communication, and vehicle-to-pedestrian (V2P) communication in vehicle-to-everything (V2X) communication.

In some embodiments, the wireless communication system may further include a network management device 13.

The several base stations 12 are connected to the network management device 13 respectively. The network management device 13 may be a core network device in a wireless communication system, for example, the network management device 13 may be a mobility management entity (MME) in an evolved packet core (EPC). Alternatively, the network management device may be another core network device, for example, a serving gate way (SGW), a public data network gate gateway (PGW), a policy and charging rules function (PCRF) unit, or a home subscriber user network device (Home Subscriber Server, HSS). An implementation of the network management device 13 is not limited in the embodiments of the present disclosure.

The following first describes some related technologies of the present disclosure.

### First, Radio Resource Management (RRM) Measurement

In a mobile communication system, the movement of a UE causes continuous changes in channel conditions around the UE. To support mobility of the UE and obtain a channel condition of a current surrounding cell of the UE in time, the network configures the UE to perform RRM measurement. The UE in the idle state and the inactive state autonomously performs cell selection or cell reselection based on the RRM measurement result, and the UE in the connected state reports the RRM measurement result to the network to assist the network in making a handover decision. In a measurement process of the UE in the connected state, a network of the NR system sends measurement configuration information to the UE in the connected state by using RRC signaling, and the UE performs intra-frequency or inter-frequency or inter-system (Radio Access Technology, RAT) measurement based on content of the measurement configuration information, and then reports a measurement result to the network. Measurement may be divided into three aspects: measurement configuration, measurement execution, and measurement reporting.

### 1. Measurement Configuration

The network performs measurement configuration by using a radio resource control (Radio Resource Control, RRC) reconfiguration process, and the measurement configuration information includes information such as a measurement object, a measurement reporting configuration, a measurement identifier, a measurement enabling threshold, a measurement gap, and measurement gap allocation.

Each group of measurements is associated and configured in an index manner, a total index is a measurement identifier, all the measurements are arranged completely according to an association relationship of the measurement identifier, and are delivered to the UE by the network side. Each measurement identifier is simultaneously connected to one measurement object identifier and one measurement reporting configuration identifier, to indicate a combination of a measurement object that needs to be measured and a measurement reporting configuration. Measurement objects and measurement reporting configurations that are not connected to a measurement identifier may also be delivered to the UE, but the UE does not perform any form of measurement for these configurations. It should be noted that each measurement identifier can be associated with only one measurement object identifier and one measurement reporting configuration identifier.

### 2. Measurement Execution

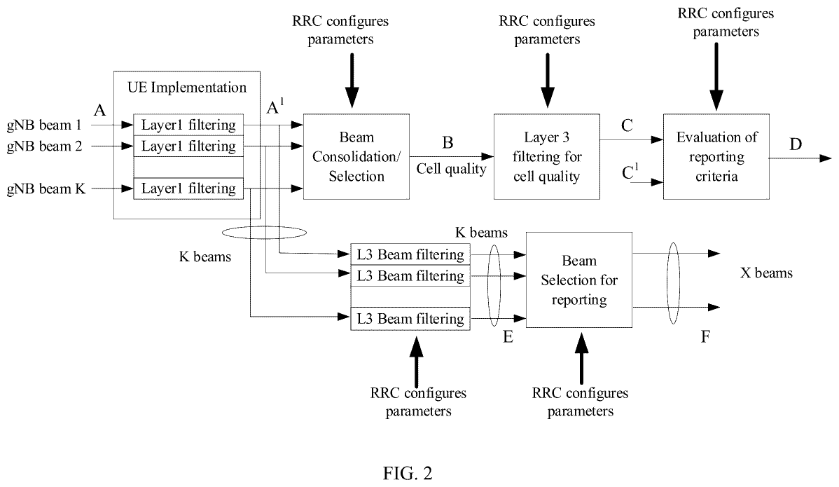

For a specific implementation process of measurement execution, refer to content shown in FIG. 2.

### 3. Measurement Reporting

The UE performs measurement based on the measurement configuration delivered by the network device, and performs reporting criterion evaluation after obtaining a cell-level measurement result. Generally, measurement reporting may be classified into event-triggered reporting and periodic reporting based on a reporting evaluation criterion. The adopted reporting evaluation criterion is determined by the measurement configuration sent to the UE.

### (1) Event-Triggered Reporting Mode

Currently, RRM events supported in an NR system include events A1, A2, A3, A4, A5, and A6, and events B1 and B2 of an inter-RAT, where six measurement events of the same system are described as follows: Event A1: the serving cell measurement result is greater than a threshold;

Event A2: the serving cell measurement result is less than a threshold; Event A3: the neighboring cell measurement result is better than the SpCell (special cell) (which may be a PCell (primary cell) or a PSCell (primary secondary cell)) measurement result; Event A4: the neighbouring cell measurement result is greater than a threshold; Event A5: a SpCell (which may be a PCell or a PSCell) measurement result is less than a first threshold, and a neighboring cell measurement result is greater than a second threshold; Event A6: a neighboring cell measurement result is better than a secondary serving cell (SCell) measurement result.

Inter-RAT measurement events supported by a current NR system is described as follows: Event B1: the measurement result of the inter-RAT neighboring cell is greater than a threshold; Event B2: a measurement result of a primary serving cell (PCell) is less than a first threshold, and a measurement result of an inter-RAT neighboring cell is greater than a second threshold.

### (2) Periodic Reporting Mode

After the measurement configuration of the network is completed, the UE measures the corresponding frequency according to the configuration content, and sends the measurement report according to the specified reporting period and interval. If the trigger type is “period”, after the maximum number of reports is reached, the UE autonomously deletes the corresponding measurement identifier in the measurement configuration variable. The measurement reporting configuration corresponding to this criterion is: the trigger type is “period”; the count of reporting is greater than 1; the reporting interval is valid, and the network sets the reporting period timer according to the configured interval parameter.

If the condition in the measurement report configuration is met, the UE will trigger measurement report reporting. A measurement report sending procedure can be referred from a procedure in a related technology. The content of the measurement report includes the following aspects: \textcircled{1} Measurement identifier.

Through the identifier, the network acquires various aspects of information from the measurement configuration stored by itself, including the measurement object corresponding to the current report, the measurement event threshold triggered by the event, the periodic trigger purpose and other contents.
\textcircled{2} All available serving cell measurement results.
\textcircled{3} According to the measurement report configuration, the measurement result of the best neighboring cell on each serving frequency is optionally carried.
\textcircled{4} A measurement result of the neighboring cell satisfying the trigger condition. Second, Uncrewed Aerial Vehicles (UAV)

In recent years, there has been a dramatic surge in global interest in services based on Uncrewed Aerial Vehicles (UAVs), encompassing various UAV operations, personal entertainment of flight experience, and cargo delivery. As a basis for these services, remote control and data transfer capabilities are key aspects of enhancement, which are of interest to service providers/operators and drone manufacturers.

Studies on UAVs have shown that the feasibility and required enhancement of connection of UAVs through ground cellular systems have been verified, and the Long Term Evolution (LTE) technology has been correspondingly enhanced in terms of uplink (UL) and downlink (DL) interference and mobility.

A height-based measurement reporting event and height reporting are introduced into the UAV. Event H1: the aerial UE height is above a threshold; Event H2: the aerial UE height is below a threshold.

In NR, applications applicable to UAVs are more diversified, and have lower latency and transmission rate requirements for terminals of UAVs. Therefore, the NR UAV needs to be enhanced based on the LTE UAV.

In a UAV, when comparing a height of a UAV UE and a height of a ground UE, as the UAV UE has more LOS (Line of Sight) connections than the ground UE, a signal measured by the UAV UE in the air does not change significantly between distances, and the UE in the air can receive a signal from a base station that is far away. This causes the UAV UEs to experience or cause more severe interference than ground UEs. This will also increase the measurement reporting of the aerial UE, which makes the mobility management of the UAV UE face great challenges.

The signal strength received by the ground terminal depends on the distance and obstacles between the ground terminal and the base station. However, such mobility management for ground terminals is not applicable to aerial UEs when the unmanned aerial vehicle rises or falls. On the one hand, almost all transmission paths between the air terminal and the base station are LOS paths; on the other hand, when the UAV moves vertically, the distance between the air terminal and the base station changes slightly. In this case, if the mobility of the unmanned aerial vehicle UE still depends on legacy mobility management (that is, mobility management for a ground terminal), a radio link failure (RLF) may be caused because the handover is too late.

In view of the above problems, in order to optimize the mobility management of the UAV UE, height-based multi-configuration enhancement is proposed. That is, the UE determines the measurement configuration to be applied according to the height information. For example, if the height of the UE belongs to a height range 1, the UE applies a corresponding configuration 1; if the height of the UE belongs to a height range 2, the UE applies a corresponding configuration 2. Alternatively, the current configuration of the UE is configuration 1, and if the height of the UE meets the threshold, the UE applies corresponding configuration 2.

The configuration 1 and the configuration 2 may correspond to different parameters, but both the configuration 1 and the configuration 2 correspond to a same measurement object (MO). Different parameters corresponding to the configuration 1 and the configuration 2 may be different parameters in an MO configuration or different parameters in a corresponding measurement reporting (MR) configuration.

For the above height-based multi-configuration enhancement, only multiple configurations based on different heights or height ranges are given. However, how to implement multiple configurations (or configuration parameters) and corresponding height or height range configuration schemes also requires research.

To this end, the present disclosure provides a measurement parameter configuration method, and various embodiments of the method proposed in the present disclosure are described in detail below.

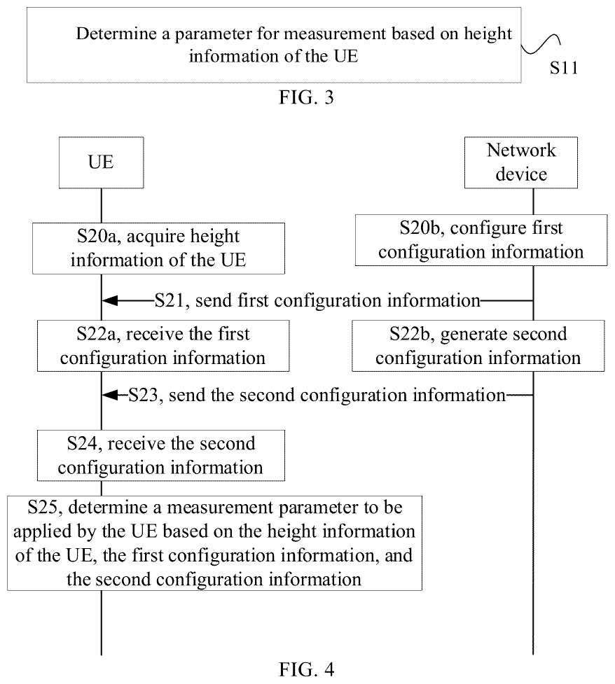

FIG. 3 is a first flowchart of a measurement parameter configuration method according to an example embodiment. As shown in FIG. 3, the measurement parameter configuration method is performed by a user equipment (UE), where the method includes: S11, determining a parameter for measurement based on height information of the UE.

According to the embodiments of the present disclosure, the parameter for measurement is determined on the basis of the height information of the UE, such that measurement parameter configuration requirements can be better met.

In some embodiments, the method further includes: the UE acquires the height information.

A specific implementation of acquiring the height information depends on the UE, for example, the UE acquires the height information in real time, or periodically acquires the height information, or acquires the height information as required, which is not limited to the embodiments of the present disclosure.

In some embodiments, S11 may specifically include: determining a measurement parameter to be applied by the UE from at least two sets of measurement parameters according to the height information and a height-based parameter selection condition.

In this embodiment, the height-based parameter selection condition may be specified in a protocol, or may be configured by a network. For example, the height-based parameter selection condition may be a height-based measurement event, for example, an event H1 or an event H2, or another height-based measurement event (for example, an event Hx). The at least two sets of measurement parameters may be different parameters in the MO configuration or different parameters in the reporting configuration.

In some embodiments, the method further includes: S12 (not shown in the figure), receiving first configuration information sent by a network device, where the first configuration information is configured to configure the height-based parameter selection condition.

In some embodiments, the first configuration information includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition. The height-based measurement event includes at least one of an event H1, an event H2, or another height-based measurement event. Another height-based measurement event may be an event Hx, which refers to an introduced new event, and a height range may be configured based on whether the height of the UE is greater than a first threshold and less than a second threshold, where the first threshold<the second threshold. For example, the second threshold may be represented as the first threshold+an offset.

For example, the first identifier being an identifier 1 indicates an event H1, the first identifier being an identifier 2 indicates an event H2, and the first identifier being an identifier 0 indicates an event Hx.

For example, the first measurement identifier being measurement identifier 1, is associated with the event H1, the second measurement identifier being measurement identifier 2, is associated with the event H2, and the third measurement identifier being measurement identifier 3, is associated with the event Hx.

For example, a threshold is configured, for example, a height-based parameter selection condition corresponding to a first threshold may be that a height is greater than the first threshold, or a height is less than the first threshold. Alternatively, two thresholds may be configured to indicate the height range of the UE, for example, the second and third thresholds are configured, indicating that the corresponding height-based parameter selection condition is that the height range is greater than the second threshold and less than the third threshold.

For example, a plurality of height ranges are configured by configuring a plurality of thresholds, and each height range corresponds to one index. For example, the index may be indexes 1, 2, 3, . . . corresponding to the height ranges, or may be high, medium, low corresponding to the height ranges.

For example, if a fourth threshold and a fifth threshold (fifth threshold>fourth threshold) are configured, index 1 (low)=the height of the UE is less than the fourth threshold, index 2 (medium)=the height of the UE is greater than the fourth threshold and less than the fifth threshold, and index 3 (high)=the height of the UE is greater than the fifth threshold.

In some embodiments, if the height-based parameter selection condition is applicable to all measurement objects, the height-based parameter selection condition includes a first number of height-based parameter selection conditions; and where a configuration of a first measurement object includes the first number of parameters used for a same purpose or the first number of parameter values corresponding to one parameter, the first measurement object is any one of the all measurement objects, and the first number is a positive integer greater than or equal to 1; where determining the measurement parameter to be applied by the UE from the at least two sets of measurement parameters according to the height information and the height-based parameter selection condition includes: for the first measurement object, determining a measurement parameter to be applied by the UE according to the height information and the height-based parameter selection condition.

In this embodiment, determining, for the first measurement object, the measurement parameter to be applied by the UE according to the height information and the height-based parameter selection condition includes: determining a parameter or a parameter value to be applied by the UE from the first number of sets of measurement parameters in the configuration of the first measurement object according to a correspondence, specified in a protocol, between the first number of parameters or the first number of parameter values and the first number of height-based parameter selection conditions, and according to the height information and the first number of height-based parameter selection conditions.

In this embodiment, if the protocol specifies that X sets of configurations determined based on the height may be configured for one measurement object, the network device may configure X height-based parameter selection conditions for the UE, where a correspondence between the height-based parameter selection conditions and to-be-applied measurement parameters is specified in the protocol, and X is a value equal to or greater than two.

For example, the protocol specifies that one measurement object may include two SSB-ToMeasure configurations, for example, SSB-ToMeasure 1 and SSB-ToMeasure 2, the network configures two height-based parameter selection conditions for the UE, for example, an event H1 and an event H2, and a correspondence specified in the protocol is as follows; \hat{ }p

| | |
|---|---|
| SSB-ToMeasure1 | Event H1 |
| SSB-ToMeasure2 | Event H2 |
| . . . | . . . |

For the configuration of all measurement objects, when the height of the UE meets event H1, the UE applies SSB-ToMeasure1; when the height of the UE meets event H2, the UE applies SSB-ToMeasure2.

In some embodiments, in response to determining that the height-based parameter selection condition is applicable to all measurement objects, determining the measurement parameter to be applied by the UE from the at least two sets of measurement parameters according to the height information and the height-based parameter selection condition includes: for the first measurement object, determining a measurement parameter to be applied by the UE according to the height information and the height-based parameter selection condition; where the configuration of the first measurement object includes two parameters used for a same purpose or two parameter values corresponding to one parameter, and the first measurement object is any one of all measurement objects.

In this embodiment, determining, for the first measurement object, the measurement parameter to be applied by the UE according to the height information and the height-based parameter selection condition includes: determining a parameter or a parameter value to be applied by the UE from two sets of measurement parameters in a configuration of a first measurement object according to the height information and the height-based parameter selection condition.

For example, it is agreed in a protocol that one measurement object may include two SSB-ToMeasure configurations, for example, SSB-ToMeasure 1 and SSB-ToMeasure 2, then a first threshold of a height may be configured, and for all measurement objects, when the height of the UE is greater than the first threshold, the UE applies SSB-ToMeasure 2, otherwise, applies SSB-ToMeasure 1.

For example, it is agreed in a protocol that one measurement object may include two SSB-ToMeasure configurations, for example, SSB-ToMeasure 1 and SSB-ToMeasure 2, then a corresponding height-based event H1 may be configured, and for all measurement objects, when the height of the UE meets the event H1, the UE applies SSB-ToMeasure 2, otherwise, it applies SSB-ToMeasure 1.

In some embodiments, in response to determining that the height-based parameter selection condition is applicable to part of measurement objects, the height-based parameter selection condition includes: a first association relationship between each condition of at least one of the height-based parameter selection conditions and a measurement object identifier applicable to the condition; where determining the measurement parameter to be applied by the UE from at least two sets of measurement parameters according to the height information and the height-based parameter selection condition includes: for a second measurement object, determining a measurement parameter to be applied by a UE.

In this embodiment, determining, for the second measurement object, the measurement parameter to be applied by the UE includes: determining, based on the first association relationship and the height information, a measurement parameter or a parameter value to be applied by the UE from multiple sets of measurement parameters or multiple parameter values of one measurement parameter corresponding to an identifier of a second measurement object, where the second measurement object is any one of the parts of measurement objects.

In this embodiment, if the protocol specifies that a plurality of height-based parameter selection conditions and MO identifiers (or reporting configuration identifiers or measurement identifiers) applicable to the conditions may be configured, the corresponding parameter selection conditions are associated with the applicable MOs (or reporting configurations or measurement identifiers). For example, if MO1 is associated with a condition 1, when the condition 1 is met, configuration a in the MO1 is applied, when the condition 1 is not met, configuration b in the MO1 is applied; and if MO2 is associated with a condition 2, when the condition 2 is met, configuration a′ in the MO2 is applied, when the condition 2 is not met, configuration b′ in the MO2 is applied. In some embodiments, in response to determining that the height-based parameter selection condition is applicable to part of measurement reporting configurations, the height-based parameter selection condition includes: a second association relationship between each condition of multiple height-based parameter selection conditions and a reporting configuration identifier applicable to the condition, or a third association relationship between each condition and a measurement identifier associated with a measurement reporting configuration of the condition; where determining the measurement parameter to be applied by the UE from the at least two sets of measurement parameters according to the height information and the height-based parameter selection condition includes: determining, based on the second association relationship and the height information, a set of measurement parameters associated with an identifier of a first reporting configuration as a measurement parameter to be applied by the UE, where the first reporting configuration is any one of the part of measurement reporting configurations; and or, determining, based on the third association relationship and the height information, a set of measurement parameters associated with a third measurement identifier as a measurement parameter to be applied by the UE, where the third measurement identifier is associated with a first reporting configuration.

In this embodiment, if a protocol specifies that a plurality of height-based parameter selection conditions and reporting configuration identifiers or measurement identifiers (or MO identifiers) applicable to the conditions are configured, the corresponding parameter selection conditions are associated with the applicable reporting configurations or measurement identifiers, where one reporting configuration or one measurement identifier is associated with only one measurement parameter configuration.

For example, if a reporting configuration 1 is associated with a condition 1, when the condition 1 is met, the reporting configuration 1 takes effect, when the condition 1 is not met, the reporting configuration 1 does not take effect; if a reporting configuration 2 is associated with a condition 2, when the condition 2 is met, the reporting configuration 2 takes effect, when the condition 2 is not met, the reporting configuration 2 does not take effect.

In some embodiments, the above method further includes: S13 (not shown in the figure): receiving second configuration information sent by a network device, where the second configuration information is configured to configure the at least two sets of measurement parameters.

In some embodiments, the second configuration information includes at least one of: at least two fields, where the at least two fields are configured to configure the at least two sets of measurement parameters, and are included in one measurement reporting configuration or one measurement object configuration; at least two second measurement identifiers, where the at least two second measurement identifiers are respectively associated with different reporting configurations of a same measurement object; a first list, where the first list is configured to modify and/or add a configuration of at least one measurement parameter in a configuration of one measurement object; and a second list, where the second list is configured to delete a configuration of at least one measurement parameter in a configuration of one measurement object; where a configuration of each measurement parameter in the first list includes a second identifier indicating a measurement parameter and corresponding configuration information, and a configuration of each measurement parameter in the second list includes a second identifier indicating a measurement parameter.

In an example, in response to the UE receiving an addition modification list sent by the network side, if a second identifier indicating a measurement parameter in the addition modification list is included in an existing measurement parameter configuration of the UE, the UE modifies the corresponding measurement parameter; if the second identifier indicating the measurement parameter in the addition modification list is not included in the existing measurement parameter configuration of the UE, the UE adds the corresponding measurement parameter into the existing measurement parameter configuration.

In this embodiment, at least two fields are fields that have a same purpose or function. Multiple sets of measurement parameters may be configured by using a plurality of fields used for the same purpose in one MO or one MR configuration.

Alternatively, multiple sets of measurement parameters may be configured by configuring a plurality of parameter values by using one field of one MO or one MR.

It should be noted that, in the foregoing embodiment, the height-based parameter selection condition is independent of measurement parameter configuration. That is, the first configuration information is used to configure height-based parameter selection conditions, and the second configuration information is used to configure at least two sets of measurement parameters.

The height-based parameter selection condition may alternatively be included in a configuration used to configure a plurality of sets of measurement parameters. That is, the second configuration information is used to configure at least two sets of measurement parameters and height-based parameter selection conditions applicable to the selection of the at least two sets of measurement parameters.

In some embodiments, the second configuration is further configured to configure the height-based parameter selection condition, and the height-based parameter selection condition is applicable to the selection of at least two sets of measurement parameters.

In some embodiments, the second configuration information includes the at least two sets of measurement parameters and a correspondence between at least one set of measurement parameters and the height-based parameter selection condition.

For example, one MO configuration includes a plurality of SSB-ToMeasure configurations, for example, SSB-ToMeasure1, SSB-ToMeasure2, and SSB-ToMeasure 3, . . . , and this configuration further includes parameter selection conditions corresponding to SSB-ToMeasure1, SSB-ToMeasure2, SSB-ToMeasure3, . . . , for example, Condition 1, Condition 2, and Condition 3. For example, one MO configuration includes two SSB-ToMeasure configurations, for example, SSB-ToMeasure1 and SSB-ToMeasure2, and this configuration further includes a corresponding parameter selection condition for applying SSB-ToMeasure2. When the UE height meets the condition, SSB-ToMeasure2 is applied, otherwise SSB-ToMeasure1 is applied.

In some embodiments, the height-based parameter selection condition includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition.

The height-based measurement event includes at least one of an event H1, an event H2, or another height-based measurement event. Another height-based measurement event may be an event Hx, which refers to an introduced new event, and a height range may be configured based on whether the height of the UE is greater than a first threshold and less than a second threshold, where the first threshold<the second threshold. For example, the second threshold may be represented as the first threshold+an offset.

The technical solution of the embodiments of the present disclosure provides a configuration solution of the height parameter and a configuration solution of the association relationship between the height and the configuration, for example, the height condition and the measurement parameter are in a one-to-many association or a one-to-one association, and on this basis, the measurement parameter to be applied by the UE is determined from at least one set of measurement parameters, thereby realizing the configuration of the measurement parameter. Based on the same inventive concept, the present disclosure further provides a measurement parameter configuration method, which is performed by a network device such as a base station. The method includes: sending configuration information to a user equipment (UE), where the configuration information is configured to configure a measurement parameter.

In some embodiments, the method further includes: in a case that a height-based parameter selection condition is configured, configure at least two sets of measurement parameters; where the height-based parameter selection condition and at least two sets of measurement parameters are configured to determine a parameter for measurement.

In this embodiment, the protocol specifies that there is a relationship between the height-based parameter selection condition configurations and a plurality of measurement parameter configurations. Only when the height-based parameter selection condition is configured, multiple sets of measurement parameters selected based on the height can be configured for the UE. In some embodiments, the configuration information includes first configuration information, and the first configuration information is configured to configure the height-based parameter selection condition.

In some embodiments, the first configuration information includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition.

The height-based measurement event includes at least one of an event H1, an event H2, or another height-based measurement event. Another height-based measurement event may be an event Hx, which refers to an introduced new event, and a height range may be configured based on whether the height of the UE is greater than a first threshold and less than a second threshold, where the first threshold<the second threshold. For example, the second threshold may be represented as the first threshold+an offset.

For example, the first identifier being an identifier 1 indicates an event H1, the first identifier being an identifier 2 indicates an event H2, and the first identifier being an identifier 0 indicates an event Hx.

For example, the first measurement identifier being measurement identifier 1 is associated with the event H1, the first measurement identifier being measurement identifier 2 is associated with the event H2, and the first measurement identifier being measurement identifier 3 is associated with the event Hx.

For example, a threshold is configured; for example, a height-based parameter selection condition corresponding to a first threshold may be that a height is greater than the first threshold, or a height is less than the first threshold. Alternatively, two thresholds may be configured to indicate the height range of the UE, for example, second and third thresholds are configured, indicating that the corresponding height-based parameter selection condition is that the height range is greater than second threshold and less than the third threshold.

For example, a plurality of height ranges are configured by configuring a plurality of thresholds, and each height range corresponds to one index. For example, the index may be indexes 1, 2, 3, . . . corresponding to the height ranges, or may be high, medium, low corresponding to the height ranges.

For example, if a fourth threshold and a fifth threshold (fifth threshold>fourth threshold) are configured, index 1 (low)=the height of the UE is less than the fourth threshold, index 2 (medium)=the height of the UE is greater than the fourth threshold and less than the fifth threshold, and index 3 (high)=the height of the UE is greater than the fifth threshold.

In some embodiments, if the height-based parameter selection condition is applicable to all measurement objects, the height-based parameter selection condition includes a first number of height-based parameter selection conditions; and the configuration information further includes second configuration information, and the second configuration information is configured to configure the first number of sets of measurement parameters; where the first number of sets of measurement parameters are included in a configuration of a first measurement object, including: the first number of parameters used for a same purpose or the first number of parameter values corresponding to one parameter, where the first measurement object is any one of the all measurement objects, and the first number is a positive integer greater than or equal to 1.

In this embodiment, if the protocol specifies that X sets of configurations determined based on the height may be configured for one MO, the network device may configure X height-based parameter selection conditions for the UE, where a correspondence between the height-based parameter selection conditions and to-be-applied measurement parameters is specified in the protocol, and X is a value equal to or greater than two.

For example, the protocol specifies that one MO may include two SSB-ToMeasure configurations, for example, SSB-ToMeasure 1 and SSB-ToMeasure 2. The network configures two height-based parameter selection conditions for the UE, for example, an event H1 and an event H2.

In some embodiments, in response to determining that the height-based parameter selection condition is applicable to all measurement objects, the configuration information further includes second configuration information, and the second configuration information is configured to configure two sets of measurement parameters.

The two sets of measurement parameters are included in a configuration of a first measurement object, including two parameters used for the same purpose or two parameter values corresponding to one parameter, and the first measurement object is any one of all the measurement objects.

For example, a protocol specifies that one MO may include two SSB-ToMeasure configurations, for example, SSB-ToMeasure 1 and SSB-ToMeasure 2, and a first height threshold may be configured for all MOs.

In some embodiments, in response to determining that the height-based parameter selection condition is applicable to part of measurement objects, the height-based parameter selection condition includes: a first association relationship between each condition of at least one of height-based parameter selection conditions and a measurement object identifier applicable to the condition; the configuration information further includes second configuration information, and the second configuration information is configured to configure multiple sets of measurement parameters.

In this embodiment, if the protocol specifies that a plurality of height-based parameter selection conditions and MO identifiers (or reporting configuration identifiers or measurement identifiers) applicable to the conditions may be configured, the corresponding parameter selection conditions are associated with the applicable MOs (or reporting configurations or measurement identifiers). For example, MO1 is associated with condition 1, and MO1 includes configuration a and configuration b; and MO2 is associated with condition 2, and MO2 includes configuration a′ and configuration b′.

In some embodiments, in response to determining that the height-based parameter selection condition is applicable to part of measurement reporting configurations, the height-based parameter selection condition includes: a second association relationship between each condition of multiple height-based parameter selection conditions and a reporting configuration identifier applicable to the condition, or a third association relationship between each condition and a measurement identifier associated with a measurement reporting configuration of the condition; the configuration information further includes second configuration information, and the second configuration information is configured to configure multiple sets of measurement parameters.

In some embodiments, the configuration information includes second configuration information, and the second configuration information is configured to configure the height-based parameter selection condition and at least two sets of measurement parameters.

In some embodiments, the second configuration information includes at least two sets of measurement parameters and a correspondence between at least one set of measurement parameters and the height-based parameter selection condition.

In this embodiment, if a protocol specifies that a plurality of height-based parameter selection conditions and reporting configuration identifiers or measurement identifiers (or MO identifiers) applicable to the conditions are configured, the corresponding parameter selection conditions are associated with the applicable reporting configurations or measurement identifiers, where one reporting configuration or one measurement identifier is associated with only one measurement parameter configuration.

For example, the reporting configuration 1 is associated with the condition 1, and the reporting configuration 2 is associated with the condition 2.

In some embodiments, the second configuration information includes at least one of: at least two fields, where the at least two fields are configured to configure the at least two sets of measurement parameters, and are included in one measurement MR configuration or one measurement object configuration; at least two second measurement identifiers, where the at least two second measurement identifiers are respectively associated with different MR configurations of a same MO; a first list, where the first list is configured to modify and/or add a configuration of at least one measurement parameter in a configuration of one measurement object; and a second list, where the second list is configured to delete a configuration of at least one measurement parameter in a configuration of one measurement object; where a configuration of each measurement parameter in the first list includes a second identifier indicating a measurement parameter and corresponding configuration information, and a configuration of each measurement parameter in the second list includes a second identifier indicating a measurement parameter.

In this embodiment, at least two fields are fields that have a same purpose or function. Multiple sets of measurement parameters may be configured by using a plurality of fields used for the same purpose in one MO or one MR configuration.

In some embodiments, the height-based parameter selection condition includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition. According to the above description, the present disclosure provides a configuration method for determining a measurement parameter based on a height, and further provides a configuration method for multiple height-based conditions applicable to determining the measurement parameter based on the height, and a configuration method applicable to a plurality of measurement parameters therein. It may be mainly implemented based on the following three aspects.

First, a configuration method for height-based parameter selection conditions is clarified, and it is proposed to indicate the height-based parameter selection condition by using a height-based measurement event, or indicate the height-based parameter selection condition by using indexes corresponding to a plurality of thresholds or height ranges.

The height-based measurement event may include an event H1, an event H2, and a newly introduced event Hx. For the new event Hx, the height range may be configured based on the height of the UE being greater than the first threshold and less than the second threshold, where the first threshold<the second threshold. For example, the second threshold may be represented as the first threshold+an offset.

Second, a height-based parameter selection condition applicable to all or some measurement configurations is configured, and a parameter selection condition corresponding to a measurement configuration is determined based on association information. Alternatively, a height-based parameter selection condition for a specific measurement parameter is configured based on each group of measurement configurations.

Third, the protocol specifies that there is a relationship between the height-based parameter selection condition configurations and a plurality of measurement parameter configurations. When a height-based parameter selection condition is configured for the UE, a plurality of sets of height-based measurement parameters are configured for the UE.

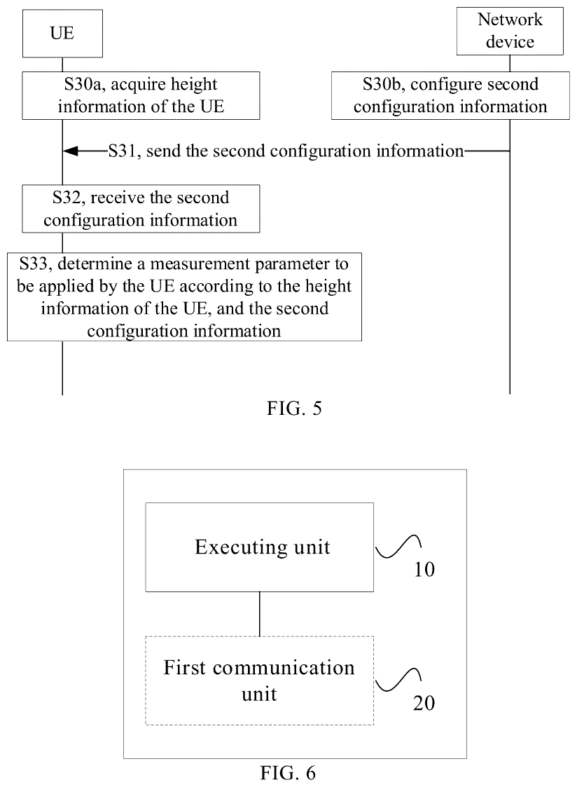

The above solutions provided by the present disclosure will be described in detail below with reference to FIGS. 4 and 5.

FIG. 4 is a second flowchart of a measurement parameter configuration method according to an example embodiment. The method shown in FIG. 4 includes following steps.

S20a, a UE acquires height information of the UE itself.

Specifically, the height information may be acquired in real time or periodically.

S20b, a network device configures first configuration information, where the first configuration information is configured to configure the height-based parameter selection condition.

S21, the network device sends the first configuration information to the UE.

S22a, the UE receives the first configuration information sent by the network device.

S22b, the network device generates second configuration information, where the second configuration information is configured to configure multiple sets of measurement parameters.

S23, the network device sends the second configuration information to the UE.

S24, the UE receives the second configuration information sent by the network device.

S25, the UE selects a measurement parameter to be applied by the UE from multiple sets of measurement parameters configured by the network based on a height-based parameter selection condition configured by the network and whether a current height of the UE meets a condition.

In this embodiment, the height-based parameter selection condition is independent of the measurement parameter configuration.

It should be noted that the execution order of steps S20a and S20b, steps S22a and S22b, and steps S21 and S23 is not limited, the steps may be performed simultaneously or sequentially, as long as the execution logic is met, which is not limited in this embodiment. FIG. 5 is a third flowchart of a measurement parameter configuration method according to an example embodiment. The method shown in FIG. 5 includes the following steps.

S30a, a UE acquires height information of the UE itself.

Specifically, the height information may be acquired in real time or periodically.

S30b, a network device configures second configuration information, where the first configuration information is configured to configure the height-based parameter selection condition.

S31, the network device sends the second configuration information to the UE.

S32, the UE receives the second configuration information sent by the network device.

S33, the UE selects a measurement parameter to be applied by the UE from multiple sets of measurement parameters configured by the network based on a height-based parameter selection condition configured by the network and whether a current height of the UE meets a condition. It should be noted that the execution order of steps S30a and S30b is not limited, the steps may be performed simultaneously or sequentially, as long as the execution logic is met, which is not limited in this embodiment.

Specifically, in the above embodiments shown in FIG. 4 and FIG. 5, configuration of the multiple sets of measurement parameters may be implemented in at least one of the following manners.

Manner 1.1: one measurement reporting (MR) configuration or measurement object (MO) configuration includes a plurality of fields with the same purpose, that is, additional fields are introduced to configure additional sets of measurement parameters.

For example, a configuration of one MO includes related configurations of a plurality of to-be-measured reference signals, for example, configuration parameters or fields of SSB-ToMeasure:

SSB-ToMeasure 1
SSB-ToMeasure 2
. . .

where SSB is an abbreviation of Synchronization Signal Block, that is, a synchronization signal block. Manner 1.2: configuration of a plurality of sets of measurement parameters is implemented by using a plurality of measurement identifiers.

For example, a measurement identifier 1 is associated with MO1 and MR configuration 1, and a measurement identifier 2 is associated with MO1 and MR configuration 2. A threshold of an event A4 and/or a count of triggered cells in the MR configuration 1 and the MR configuration 2 are different, thereby implementing the configuration of multiple thresholds of A4 and/or multiple counts of triggered cells.

For example, as shown in the following table.

Measure Report Config1 (first threshold of Event A4)
Measure Report Config2 (second threshold of Event A4)
. . .

Manner 1.3: an add list is configured to configure a plurality of sets of measurement parameters. For example, configuration of a plurality of SSB-ToMeasure configurations included in one MO configuration is implemented by using the add list, each SSB-ToMeasure configuration corresponds to one configuration identifier and corresponding configuration information, and a configuration of SSB-ToMeasure in the MO is added by using the add list. Each entry in the add list corresponds to one configuration ID and corresponding configuration information, for example, as shown in the following table.

| | |
|---|---|
| ID 1 | SSB-ToMeasure 1 |
| ID 2 | SSB-ToMeasure 2 |
| . . . | |

Manner 1.4: a mod list is configured to configure a plurality of sets of measurement parameters. For example, configuration of a plurality of SSB-ToMeasure configurations included in one MO configuration is implemented by using the mod list, each SSB-ToMeasure configuration corresponds to one configuration identifier and corresponding configuration information, and a configuration of SSB-ToMeasure in the MO is modified by using the mod list. Each entry in the mod list corresponds to one configuration ID and corresponding configuration information, for example, as shown in the following table.

| | |
|---|---|
| ID 1 | SSB-ToMeasure 1 |
| ID 2 | SSB-ToMeasure 2 |
| . . . | |

Manner 1.5: a remove list is configured to configure a plurality of sets of measurement parameters. For example, configuration of a plurality of SSB-ToMeasure configurations included in one MO configuration is implemented by using the remove list, and a configuration of SSB-ToMeasure in the MO is removed by using the remove list. The remove list includes one or more configuration IDs, for example, as shown in the following table.

ID 1
ID 2
. . .

In the above embodiments shown in FIG. 4 and FIG. 5, the height-based parameter selection condition may be configured in one or more of the following manners.

Manner 2.0: a height-based measurement event.

Manner 2.1: a configuration of the height-based measurement event.

Manner 2.2: a first identifier indicating the height-based measurement event.

The height-based measurement event may include an event H1, an event H2, and a new event Hx.

The event H1 indicates that a height of the UE is greater than a threshold, the event H2 indicates that the height of the UE is less than the threshold, and the event Hx may be used to configure a height range. For example, the event Hx may indicate that the height of the UE is greater than the first threshold and less than the second threshold. The first threshold<the second threshold. For example, the second threshold may be represented as the first threshold+an offset.

In other words, the height-based measurement event may be directly configured, or the height-based measurement event may be indicated by configuring the first identifier.

Manner 2.3: a measurement identifier associated with the height-based measurement event.

Manner 2.4: one or more height thresholds associated with the height-based parameter selection conditions.

For example, a condition corresponding to a first height threshold configured by the network may be that the height is greater than the first threshold, or the height is less than the first threshold.

For example, the network may also indicate the height range of the UE by configuring two thresholds, for example, configuring the second and third thresholds, indicating that a corresponding condition is that the height range is greater than the second threshold and less than the third threshold.

Manner 2.5: an index corresponding to the height-based parameter selection condition.

Specifically, the network may configure multiple height ranges by configuring multiple thresholds, and each height range corresponds to one index, for example, the index may be index values 1, 2, 3, etc., or may be high, medium, low, etc.

For example, if the UE configures a fourth threshold and a fifth threshold (fifth threshold>fourth threshold), index 1 (low)=the height of the UE is less than the fourth threshold, index 2 (medium)=the height of the UE is greater than the fourth threshold and less than the fifth threshold, and index 3 (high)=the height of the UE is greater than the fifth threshold.

Manner 2.6: a report configuration identifier associated with the height-based measurement event. The height-based parameter selection condition supports the configuration of a hysteresis value and a trigger time. The trigger time refers to a time that meets the trigger condition, and the hysteresis value is introduced to avoid ping-ponging. That is, the height-based parameter selection condition needs to be triggered only when the trigger condition is met, and needs to meet a corresponding hysteresis value of the condition.

For example, for the event H1 (the height of the aerial UE is higher than the threshold), when the UE meets the following specified condition H1-1, it is considered that an entering condition of the event is met; and when the UE meets the following specified condition H1-2, it is considered that a leaving condition of the event is met.

Condition H1-1 (entering condition): Ms−Hys>Thresh+Offset: Condition H1-2 (leaving condition): Ms+Hys<Thresh+Offset; Ms represents a height of the aerial UE regardless of any offset; Hys represents a hysteresis parameter of this event (i.e., h1 hysteresis value defined in the EUTRA configuration report); Thresh represents a reference threshold parameter for this event given in the configuration measurement (i.e.: height Thresh Ref defined in Meas Config); Offset represents an offset value of height Thresh Ref, and is used to obtain an absolute threshold of the event (that is, h1 Threshold Offset defined in the EUTRA configuration report); Ms is measured in meters; Thresh is represented using the same unit as Ms.

For event H2 (the height of the aerial UE below threshold).

When the UE satisfies the following specified condition H2-1, it is considered that the entering condition of the event is satisfied; and when the UE satisfies the following specified condition H2-2, it is considered that the leaving condition of the event is satisfied.

Condition H2-1 (entering condition): Ms+Hys<Thresh+Offset; Condition H2-2 (leaving condition): Ms−Hys>Thresh+Offset; Ms represents a height of the aerial UE regardless of any offset; Hys represents a hysteresis parameter of this event (i.e., h2 hysteresis value defined in the EUTRA configuration report); Thresh represents a reference threshold parameter for this event given in the configuration measurement (i.e.: height Thresh Ref defined in Meas Config); Offset represents an offset value of height Thresh Ref, and is used to obtain an absolute threshold of the event (that is, h2 Threshold Offset defined in the EUTRA configuration report); Ms is measured in meters; Thresh is represented using the same unit as Ms.

In the embodiment shown in FIG. 4, the height-based parameter selection condition is independent of measurement parameter configuration. The height-based parameter selection condition may be used for all or some measurement objects. Specific implementations include, but are not limited to, one or more of the following.

Manner 3.1: if it is specified in a protocol that at least two height-based configurations may be configured for one MO, the network side needs to configure at least two height ranges (or height-based parameter selection conditions) for the UE, and a correspondence between the height-based parameter selection conditions and measurement parameters applied by the UE is specified in the protocol.

For example, a protocol specifies that one MO may include two SSB-ToMeasure configurations, e.g., SSB-ToMeasure 1 and SSB-ToMeasure 2, the network may configure a first height threshold, and for all MO configurations, when the height of the UE is greater than the first threshold, the UE applies SSB-ToMeasure 2, otherwise, applies SSB-ToMeasure 1.

Manner 3.2: the protocol configures a plurality of height-based parameter selection conditions and MO identifiers (or a measurement reporting configuration identifier or a measurement identifier) to which the conditions are applicable, and a corresponding parameter selection condition is associated with an applicable MO (or a measurement reporting configuration or a measurement identifier).

For example, if MO1 is associated with a condition 1, when the condition 1 is met, configuration a in the MO1 is applied, when the condition 1 is not met, configuration b in the MO1 is applied; and if MO2 is associated with a condition 2, when the condition 2 is met, configuration a′ in the MO2 is applied, when the condition 2 is not met, configuration b′ in the MO2 is applied.

Manner 3.3: if a protocol configures a plurality of height-based parameter selection conditions and measurement reporting configuration identifiers or measurement identifiers applicable to the conditions, the corresponding parameter selection conditions are associated with the applicable measurement reporting configurations or measurement identifiers, where one measurement reporting configuration or one measurement identifier is associated with only one configuration.

For example, if a measurement reporting configuration 1 is associated with a condition 1, when the condition 1 is met, the measurement reporting configuration 1 takes effect, when the condition 1 is not met, the measurement reporting configuration 1 does not take effect; if a measurement reporting configuration 2 is associated with a condition 2, when the condition 2 is met, the measurement reporting configuration 2 takes effect, when the condition 2 is not met, the measurement reporting configuration 2 does not take effect.

In the embodiment shown in FIG. 5, the height-based parameter selection condition is included in a configuration used to configure a plurality of measurement parameters, for example, included in an MO configuration or a measurement reporting configuration, and the parameter selection condition included in the configuration used to configure the plurality of measurement parameters is only applicable to selection of the plurality of measurement parameters.

For example, one MO configuration includes multiple SSB-ToMeasure configurations, for example, SSB-ToMeasure1, SSB-ToMeasure2, SSB-ToMeasure3, . . . , and this configuration further includes a corresponding parameter selection condition for applying SSB-ToMeasure1, SSB-ToMeasure2, SSB-ToMeasure3, The configuration of one MO includes following information:

| | |
|---|---|
| SSB-ToMeasure1 | Condition 1 |
| SSB-ToMeasure2 | Condition 2 |
| SSB-ToMeasure3 | Condition 3 |
| . . . | |

For example, one MO configuration includes two SSB-ToMeasure configurations, for example, SSB-ToMeasure1 and SSB-ToMeasure2, and this configuration further includes a corresponding parameter selection condition for applying SSB-ToMeasure2. When the UE height meets the condition, SSB-ToMeasure2 is applied, otherwise SSB-ToMeasure1 is applied.

The condition in the foregoing two example solutions may be represented by one measurement identifier, one height-based measurement event configuration, a first identifier used to indicate a height-based measurement event, or one index.

In the foregoing embodiments shown in FIG. 4 and FIG. 5, if the protocol specifies that there is a relationship between the configuration of the height-based parameter selection condition and the configuration of the plurality of measurement parameters, the network side configures the plurality of sets of measurement parameters determined based on the height in a case where the height-based parameter selection condition is configured.

Manner 4.1: in a case that a height-based parameter selection condition is a general condition and is applicable to all measurement parameters, if at least one parameter selection condition is configured, a plurality of sets of measurement parameters determined based on the height are configured in one MO configuration (or one MR configuration); otherwise, the configuration is not supported.

For example, if the network side configures a height-based parameter selection condition for the UE, for example, event Hx, when configuring MO1, the network side may include configurations corresponding to SSB-ToMeasure1 and SSB-ToMeasure2; or if no height-based parameter selection condition is configured, when configuring MO1, the network side may include only a configuration corresponding to SSB-ToMeasure1.

Manner 4.2: for a height-based parameter selection condition applicable to part of MOs (or part of MRs), if at least one parameter selection condition applicable to the MO or the MR is configured, a plurality of sets of measurement parameters determined based on height are configured in the configuration of the MO (or the configuration of the MR); otherwise, the configuration is not supported.

For example, if the network side configures a height-based parameter selection condition for the UE, for example, an event Hx, and MR configurations associated with the condition are an MR configuration 1 and an MR configuration 3, when the network side configures the MR configuration 1 (or the MR configuration 3), configurations corresponding to a first count of triggered cells and the a second count of triggered cells may be included; and if the height-based parameter selection condition is not configured, when the network side configures the MR configuration 2, only the configuration corresponding to the first count of triggered cells may be included.

Manner 4.3: if the height-based parameter selection condition is included in a configuration used to configure a plurality of sets of measurement parameters (for example, included in a configuration of an MO or an MR), and is only applicable to the MO or the MR, only when the configuration of the MO or the configuration of the MR includes the height-based parameter selection condition, the configuration of the MO or the configuration of the MR may include the plurality of sets of measurement parameters determined based on height, otherwise, the configuration is not supported.

For example, if the configuration of the MO1 includes the height-based parameter selection condition, for example, the measurement identifier corresponding to the event Hx, when configuring the MO1, the network side may include configurations corresponding to SSB-ToMeasure1 and SSB-ToMeasure2; or if the configuration of the MO1 does not include the height-based parameter selection condition, when configuring the MO1, the network side may include only a configuration corresponding to SSB-ToMeasure1.

FIG. 6 is a first block diagram of a measurement parameter configuration apparatus according to an example embodiment. The measurement parameter configuration apparatus is applied to a UE side, and referring to FIG. 6, the apparatus includes an executing unit 10.

An executing unit 10, is configured to determine a parameter for measurement based on height information of the UE.

In the above solution, the executing unit 10 is configured to: determine a measurement parameter to be applied by the UE from at least two sets of measurement parameters according to the height information and a height-based parameter selection condition.

In some embodiments, the apparatus further includes a first communication unit 20.

The first communication unit 20 is configured to receive first configuration information sent by a network device, where the first configuration information is configured to configure the height-based parameter selection condition.

In the above solution, the first configuration information includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition. In some embodiments, if the height-based parameter selection condition is applicable to all measurement objects, the height-based parameter selection condition includes a first number of height-based parameter selection conditions; and where a configuration of a first measurement object includes the first number of parameters used for a same purpose or the first number of parameter values corresponding to one parameter, the first measurement object is any one of all the measurement objects, and the first number is a positive integer greater than or equal to 1; the executing unit 10 is configured to determine a parameter or a parameter value to be applied by the UE from the first number of sets of measurement parameters in the configuration of the first measurement object according to a correspondence, specified in a protocol, between the first number of parameters or the first number of parameter values and the first number of height-based parameter selection conditions, and according to the height information and the first number of height-based parameter selection conditions.

In some embodiments, in a case that the height-based parameter selection condition is applicable to all measurement objects, the configuration of the first measurement object includes two parameters used for a same purpose or two parameter values corresponding to one parameter, and the first measurement object is any one of all measurement objects.
the executing unit 10 is configured to determine a parameter or a parameter value to be applied by the UE from two sets of measurement parameters in a configuration of a first measurement object according to the height information and the height-based parameter selection condition.

In some embodiments, in response to determining that the height-based parameter selection condition is applicable to part of measurement objects, the height-based parameter selection condition includes: a first association relationship between each condition of at least one of height-based parameter selection condition and a measurement object identifier applicable to the condition.

The executing unit 10 is configured to determine, based on the first association relationship and the height information, a measurement parameter or a parameter value to be applied by the UE from multiple sets of measurement parameters or multiple parameter values of one measurement parameter corresponding to an identifier of a second measurement object, where the second measurement object is any one of the part of measurement objects.

In some embodiments, in response to determining that the height-based parameter selection condition is applicable to part of measurement reporting configurations, the height-based parameter selection condition includes: a second association relationship between each condition of multiple height-based parameter selection conditions and a reporting configuration identifier applicable to the condition, or a third association relationship between each condition and a measurement identifier associated with a measurement reporting configuration of the condition; the executing unit 10 is configured to: determine, based on the second association relationship and the height information, a set of measurement parameters associated with an identifier of a first reporting configuration as a measurement parameter to be applied by the UE, where the first reporting configuration is any one of the part of measurement reporting configurations; and or, determine, based on the third association relationship and the height information, a set of measurement parameters associated with a third measurement identifier as a measurement parameter to be applied by the UE, where the third measurement identifier is associated with a first reporting configuration.

In some embodiments, the first communication unit 20 is further configured to receive second configuration information sent by a network device, where the second configuration information is configured to configure at least two sets of measurement parameters.

In the above solution, the second configuration information includes at least one of: at least two fields, where the at least two fields are configured to configure the at least two sets of measurement parameters, and are included in one measurement reporting configuration or one measurement object configuration; at least two second measurement identifiers, where the at least two second measurement identifiers are respectively associated with different reporting configurations of a same measurement object; a first list, where the first list is configured to modify and/or add a configuration of at least one measurement parameter in a configuration of one measurement object; and a second list, where the second list is configured to delete a configuration of at least one measurement parameter in a configuration of one measurement object; where a configuration of each measurement parameter in the first list includes a second identifier indicating a measurement parameter and corresponding configuration information, and a configuration of each measurement parameter in the second list includes a second identifier indicating a measurement parameter.

In some embodiments, the second configuration is further configured to configure the height-based parameter selection condition, and the height-based parameter selection condition is applicable to selection of the at least two sets of measurement parameters.

In the above solution, the second configuration information includes the at least two sets of measurement parameters and a correspondence between at least one set of measurement parameters and the height-based parameter selection condition.

In the above solution, the height-based parameter selection condition includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition.

In the above solution, the height-based measurement event includes at least one of an event H1, an event H2, or another height-based measurement event.

For the apparatus in the above embodiments, the specific manner in which each unit performs operations has been described in detail in the embodiments of the related methods, and will not be repeated in detail here.

In actual application, specific structures of the executing unit 10 and the first communication unit 20 may be implemented by a central processing unit (CPU), a microprocessor (MCU), a digital signal processor (DSP), a programmable logic device (PLC), or the like in the measurement parameter configuration apparatus or the terminal to which the measurement parameter configuration apparatus belongs.

The measurement parameter configuration apparatus in this embodiment may be disposed on a UE side.

Those skilled in the art should understand that the functions of each unit in the measurement parameter configuration apparatus according to the embodiments of the present disclosure may be understood with reference to the related description of the measurement parameter configuration method performed by the UE side. The functions of the units in the measurement parameter configuration apparatus in the embodiments of the present disclosure may be implemented by analog circuits that implement the functions described in the embodiments of the present disclosure, or may be implemented by running software that performs the functions described in the embodiments of the present disclosure on a terminal.

The measurement parameter configuration apparatus according to the embodiment of the present disclosure can better meet the configuration requirements of the measurement parameter.

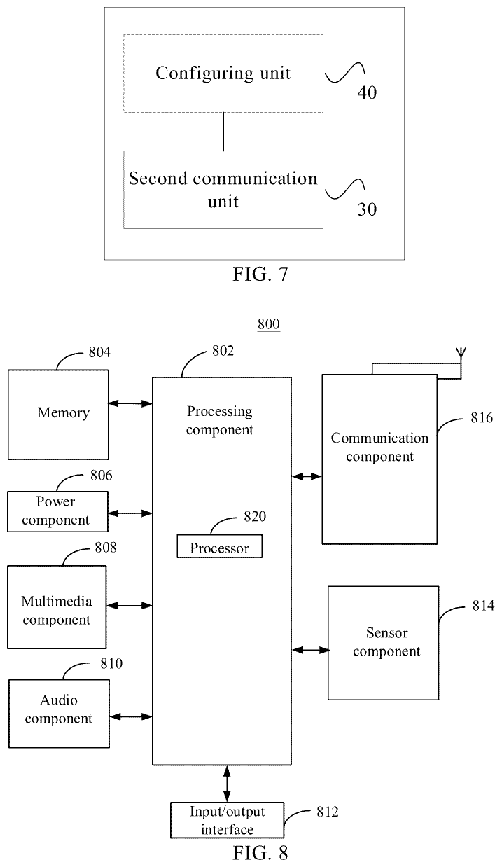

FIG. 7 is a second block diagram of a measurement parameter configuration apparatus according to an example embodiment. The measurement parameter configuration apparatus is applied to a network device such as a base station side, and referring to FIG. 7, the apparatus includes: a second communication unit 30, configured to send configuration information to a user equipment (UE), where the configuration information is configured to configure a measurement parameter.

In some embodiments, the apparatus further includes a configuring unit 40.

The configuring unit 40 is configured to: in a case that a height-based parameter selection condition is configured, configure at least two sets of measurement parameters; where the height-based parameter selection condition and the at least two sets of measurement parameters are configured to determine a parameter for measurement.

In the above solution, the configuration information includes first configuration information, and the first configuration information is configured to configure the height-based parameter selection condition.

In the above solution, the first configuration information includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; and an index corresponding to the height-based parameter selection condition. In some embodiments, if the height-based parameter selection condition is applicable to all measurement objects, the height-based parameter selection condition includes a first number of height-based parameter selection conditions; and the configuration information further includes second configuration information, and the second configuration information is configured to configure the first number of sets of measurement parameters; where the first number of sets of measurement parameters are included in a configuration of a first measurement object, including: the first number of parameters used for a same purpose or the first number of parameter values corresponding to one parameter, where the first measurement object is any one of the all measurement objects, and the first number is a positive integer greater than or equal to 1.

In some embodiments, if the height-based parameter selection condition is applicable to all measurement objects, the height-based parameter selection condition includes height-based parameter selection conditions; and the configuration information further includes second configuration information, and the second configuration information is configured to configure two sets of measurement parameters.

The two sets of measurement parameters are included in a configuration of a first measurement object, including two parameters used for the same purpose or two parameter values corresponding to one parameter, and the first measurement object is any one of the all measurement objects.

In some embodiments, in response to determining that the height-based parameter selection condition is applicable to part of measurement objects, the height-based parameter selection condition includes: a first association relationship between each condition of at least one of height-based parameter selection condition and a measurement object identifier applicable to the condition; the configuration information further includes second configuration information, and the second configuration information is configured to configure multiple sets of measurement parameters.

In some embodiments, in response to determining that the height-based parameter selection condition is applicable to part of measurement reporting configurations, the height-based parameter selection condition includes: a second association relationship between each condition of multiple height-based parameter selection conditions and a reporting configuration identifier applicable to the condition, or a third association relationship between each condition and a measurement identifier associated with a measurement reporting configuration of the condition; the configuration information further includes second configuration information, and the second configuration information is configured to configure multiple sets of measurement parameters. In some embodiments, the configuration information includes second configuration information, and the second configuration information is configured to configure the height-based parameter selection condition and the at least two sets of measurement parameters.

In the above solution, the second configuration information includes the at least two sets of measurement parameters and a correspondence between at least one set of measurement parameters and the height-based parameter selection condition.

In the above solution, the second configuration information includes at least one of: at least two fields, where the at least two fields are configured to configure the at least two sets of measurement parameters, and are included in one measurement reporting configuration or one measurement object configuration; at least two second measurement identifiers, where the at least two second measurement identifiers are respectively associated with different reporting configurations of a same measurement object; a first list, where the first list is configured to modify and/or add a configuration of at least one measurement parameter in a configuration of one measurement object; and a second list, where the second list is configured to delete a configuration of at least one measurement parameter in a configuration of one measurement object; where a configuration of each measurement parameter in the first list includes a second identifier indicating a measurement parameter and corresponding configuration information, and a configuration of each measurement parameter in the second list includes a second identifier indicating a measurement parameter.

In the above solution, the height-based parameter selection condition includes at least one of: a height-based measurement event; a configuration of the height-based measurement event; a first identifier indicating the height-based measurement event; a first measurement identifier associated with the height-based measurement event; a report configuration identifier associated with the height-based measurement event; at least one threshold value associated with the height-based parameter selection condition; or an index corresponding to the height-based parameter selection condition.

In the above solution, the height-based measurement event includes at least one of an event H1, an event H2, or another height-based measurement event.

For the apparatus in the above embodiments, the specific manner in which each unit performs operations has been described in detail in the embodiments of the related methods, and will not be repeated in detail here.

In actual application, specific structures of the second communication unit 30 and the configuring unit 40 may be implemented by a CPU, an MCU, a DSP, a PLC, or the like in the measurement parameter configuration apparatus or the base station to which the measurement parameter configuration apparatus belongs.

The measurement parameter configuration apparatus in this embodiment may be disposed on a network device, such as a base station side.

Those skilled in the art should understand that the functions of each unit in the measurement parameter configuration apparatus according to the embodiments of the present disclosure may be understood with reference to the related description of the measurement parameter configuration method performed by the network device, such as the base station. The functions of the units in the measurement parameter configuration apparatus in the embodiments of the present disclosure may be implemented by analog circuits that implement the functions described in the embodiments of the present disclosure, or may be implemented by running software that performs the functions described in the embodiments of the present disclosure on a base station.

The measurement parameter configuration apparatus according to the embodiment of the present disclosure can better meet the configuration requirements of the measurement parameter. Based on the same principle as the method provided by the embodiments of the present disclosure, the embodiments of the present disclosure further provides a communication device, which includes a memory and a processor, where the memory stores a computer program, and the processor, when running the computer program stored in the memory, can execute the measurement parameter configuration method provided by any optional embodiment of the present disclosure.

The present disclosure further provides a communication system, including a user equipment and a network device, where the user equipment is configured to implement the measurement parameter configuration method on a UE side in any optional embodiment of the present disclosure, and the network device is configured to implement the measurement parameter configuration method on a base station side in any optional embodiment of the present disclosure. An embodiment of the present disclosure further provides a computer-readable storage medium, where the storage medium stores a computer program, and when the computer program is executed by a processor, the measurement parameter configuration method provided in any optional embodiment of the present disclosure may be performed.

FIG. 8 is a block diagram of a device 800 for implementing measurement parameter configuration according to an example embodiment. For example, the apparatus 800 may be a mobile phone, a computer, a digital broadcast terminal, a messaging device, a gaming console, a tablet device, a medical device, exercise equipment, a personal digital assistant, etc.

Referring to FIG. 8, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules that facilitate the interaction between the processing component 802 and other components. For example, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. The front camera and the rear camera may receive an external multimedia datum while the device 800 is in an operation mode, such as a photographing mode or a video mode. Each of the front and rear cameras may be a fixed optical lens system or have a focal length and optical zoom capability.

The audio component 810 is configured to output and/or input audio signals. For example, the audio component 810 includes a microphone (MIC) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, such as a keyboard, a click wheel, buttons, and the like. These buttons may include, but are not limited to, home buttons, volume buttons, start buttons, and lock buttons. The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without requiring any physical contact. The sensor component 814 may also include a light sensor, such as a complementary metal oxide semiconductor (CMOS) or charge-coupled device (CCD) image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as Wi-Fi, 2G or 3G, or a combination thereof. In an example embodiment, the communication component 816 receives a broadcast signal or broadcast associated information from an external broadcast management system via a broadcast channel. In an example embodiment, the communication component 816 further includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example embodiment, the device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors or other electronic elements, and is configured to execute the above measurement parameter configuration method applied to a user terminal side.

In an example embodiment, there is also provided a non-transitory computer storage medium including executable instructions, such as included in the memory 804, executable instructions executable by the processor 820 in the device 800, for performing the above-described methods. For example, the non-transitory computer storage medium may be a ROM (read-only memory), a RAM (random access memory), CD-ROM (compact disc read-only memory), magnetic tape, floppy disk, optical data storage device, or the like.

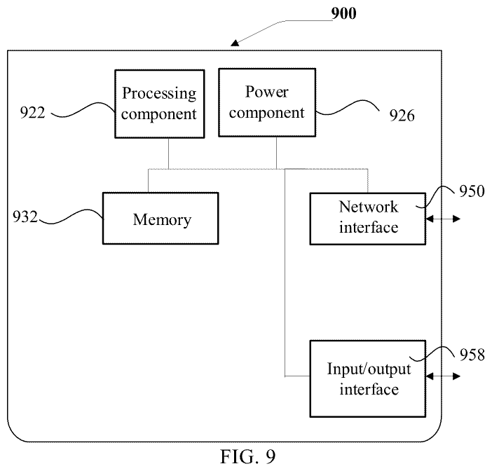

FIG. 9 is a block diagram of a device 900 for implementing measurement parameter configuration according to an example embodiment. Referring to FIG. 9, the device 900 includes a processing component 922, which further includes one or more processors, and memory resources represented by a memory 932 for storing instructions executable by the processing component 922, such as application programs. The application program stored in the memory 932 may include one or more modules each corresponding to a set of instructions. In addition, the processing component 922 is configured to execute instructions to perform the above measurement parameter configuration method applied to a network device side.

The device 900 may further include a power component 926 configured to perform power management of the device 900, a wired or wireless network interface 950 configured to connect the device 900 to a network, and an input/output (I/O) interface 958. The device 900 may operate based on an operating system stored in the memory 932, such as Windows Server™, Mac OS XTM, Unix™, Linux™, Free BSD™, or the like.

The technical solutions described in the embodiments of the present disclosure may be combined in any way on a non-conflict basis.

Other embodiments of the present disclosure will be apparent to those skilled in the art from consideration of the specification and practice of the present disclosure disclosed herein. The present disclosure is intended to cover any variations, uses, or adaptations of the present disclosure following the general principles thereof and including such departures from the present disclosure as come within known or customary practice in the art. It is intended that the specification and examples be considered as examples only, with a true scope and spirit of the disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. A measurement parameter configuration method, performed by a user equipment (UE), comprising:
determining a parameter for measurement based on height information of the UE.

2. The method according to claim 1, wherein determining the parameter for measurement based on the height information of the UE comprises:
determining a measurement parameter to be applied by the UE from at least two sets of measurement parameters according to the height information and a height-based parameter selection condition.

3. The method according to claim 2, further comprising:
receiving first configuration information sent by a network device, wherein the first configuration information is configured to configure the height-based parameter selection condition.

4. The method according to claim 3, wherein the first configuration information comprises at least one of:
a height-based measurement event;
a configuration of the height-based measurement event;
a first identifier indicating the height-based measurement event;
a first measurement identifier associated with the height-based measurement event;
a report configuration identifier associated with the height-based measurement event;
at least one threshold value associated with the height-based parameter selection condition; or
an index corresponding to the height-based parameter selection condition.

5. The method according to claim 2, wherein in response to determining that the height-based parameter selection condition is applicable to all measurement objects, the height-based parameter selection condition comprises a first number of height-based parameter selection conditions;
wherein a configuration of a first measurement object comprises the first number of parameters used for a same purpose or the first number of parameter values corresponding to one parameter, the first measurement object is any one of the all measurement objects, and the first number is a positive integer greater than or equal to 1;
wherein determining the measurement parameter to be applied by the UE from the at least two sets of measurement parameters according to the height information and the height-based parameter selection condition comprises:
determining a parameter or a parameter value to be applied by the UE from a first number of sets of measurement parameters in the configuration of the first measurement object according to a correspondence, specified in a protocol, between the first number of parameters or the first number of parameter values and the first number of height-based parameter selection conditions, and according to the height information and the first number of height-based parameter selection conditions.

6. The method according to claim 2, wherein in response to determining that the height-based parameter selection condition is applicable to all measurement objects, determining the measurement parameter to be applied by the UE from the at least two sets of measurement parameters according to the height information and the height-based parameter selection condition comprises:
determining a parameter or a parameter value to be applied by the UE from two sets of measurement parameters in a configuration of a first measurement object according to the height information and the height-based parameter selection condition;
wherein the configuration of the first measurement object comprises two parameters used for a same purpose or two parameter values corresponding to one parameter, and the first measurement object is any one of all measurement objects.

7. The method according to claim 2, wherein in response to determining that the height-based parameter selection condition is applicable to part of measurement objects, the height-based parameter selection condition comprises: a first association relationship between each condition of at least one of height-based parameter selection condition and a measurement object identifier applicable to the condition;
wherein determining the measurement parameter to be applied by the UE from the at least two sets of measurement parameters according to the height information and the height-based parameter selection condition comprises:
determining, based on the first association relationship and the height information, a measurement parameter or a parameter value to be applied by the UE from multiple sets of measurement parameters or multiple parameter values of one measurement parameter corresponding to an identifier of a second measurement object, wherein the second measurement object is any one of the part of measurement objects.

8. The method according to claim 2, wherein in response to determining that the height-based parameter selection condition is applicable to part of measurement reporting configurations, the height-based parameter selection condition comprises: a second association relationship between each condition of multiple height-based parameter selection conditions and a reporting configuration identifier applicable to the condition, or a third association relationship between each condition and a measurement identifier associated with a measurement reporting configuration of the condition;
wherein determining the measurement parameter to be applied by the UE from the at least two sets of measurement parameters according to the height information and the height-based parameter selection condition comprises:
determining, based on the second association relationship and the height information, a set of measurement parameters associated with an identifier of a first reporting configuration as a measurement parameter to be applied by the UE, wherein the first reporting configuration is any one of the part of measurement reporting configurations; and
or,
determining, based on the third association relationship and the height information, a set of measurement parameters associated with a third measurement identifier as a measurement parameter to be applied by the UE, wherein the third measurement identifier is associated with a first reporting configuration.

9. The method according to claim 2, further comprising:
receiving second configuration information sent by a network device, wherein the second configuration information is configured to configure the at least two sets of measurement parameters.

10. The method according to claim 9, wherein the second configuration information comprises at least one of:
at least two fields, wherein the at least two fields are configured to configure the at least two sets of measurement parameters, and are comprised in one measurement reporting configuration or one measurement object configuration;
at least two second measurement identifiers, wherein the at least two second measurement identifiers are respectively associated with different reporting configurations of a same measurement object;
a first list, wherein the first list is configured to modify and/or add a configuration of at least one measurement parameter in a configuration of one measurement object; and
a second list, wherein the second list is configured to delete a configuration of at least one measurement parameter in a configuration of one measurement object;
wherein a configuration of each measurement parameter in the first list comprises a second identifier indicating a measurement parameter and corresponding configuration information, and a configuration of each measurement parameter in the second list comprises a second identifier indicating a measurement parameter.

11. The method according to claim 10, wherein the second configuration information is further configured to configure the height-based parameter selection condition, and the height-based parameter selection condition is applicable to selection of the at least two sets of measurement parameters;
wherein the second configuration information comprises the at least two sets of measurement parameters and a correspondence between at least one set of measurement parameters and the height-based parameter selection condition;
wherein the height-based parameter selection condition comprises at least one of:
a height-based measurement event;
a configuration of the height-based measurement event;
a first identifier indicating the height-based measurement event;
a first measurement identifier associated with the height-based measurement event;
a report configuration identifier associated with the height-based measurement event;
at least one threshold value associated with the height-based parameter selection condition; or
an index corresponding to the height-based parameter selection condition.

12.-13. (canceled)

14. The method according to claim 4, wherein the height-based measurement event comprises at least one of an event H1, an event H2, or another height-based measurement event.

15. A measurement parameter configuration method, performed by a network device, comprising:
sending configuration information to a user equipment (UE), wherein the configuration information is configured to configure a measurement parameter.

16. The method according to claim 15, further comprising:
in a case that a height-based parameter selection condition is configured, configuring at least two sets of measurement parameters;
wherein the height-based parameter selection condition and the at least two sets of measurement parameters are configured to determine a parameter for measurement.

17. The method according to claim 16, wherein the configuration information comprises first configuration information, and the first configuration information is configured to configure the height-based parameter selection condition;
wherein the first configuration information comprises at least one of:
a height-based measurement event, comprising at least one of an event H1, an event H2, or another height-based measurement event;
a configuration of the height-based measurement event;
a first identifier indicating the height-based measurement event;
a first measurement identifier associated with the height-based measurement event;
a report configuration identifier associated with the height-based measurement event;
at least one threshold value associated with the height-based parameter selection condition; or
an index corresponding to the height-based parameter selection condition;
in response to determining that the height-based parameter selection condition is applicable to all measurement objects, the height-based parameter selection condition comprises a first number of height-based parameter selection conditions;
the configuration information further comprises second configuration information, and the second configuration information is configured to configure the first number of sets of measurement parameters;
wherein the first number of sets of measurement parameters are comprised in a configuration of a first measurement object, comprising: the first number of parameters used for a same purpose or the first number of parameter values corresponding to one parameter, wherein the first measurement object is any one of the all measurement objects, and the first number is a positive integer greater than or equal to 1; or
wherein in response to determining that the height-based parameter selection condition is applicable to all measurement objects, the configuration information further comprises second configuration information, and the second configuration information is configured to configure two sets of measurement parameters;
wherein the two sets of measurement parameters are comprised in a configuration of a first measurement object, comprising two parameters used for a same purpose or two parameter values corresponding to one parameter, and the first measurement object is any one of the all measurement objects; or
wherein in response to determining that the height-based parameter selection condition is applicable to part of measurement objects, the height-based parameter selection condition comprises: a first association relationship between each condition of at least one of height-based parameter selection condition and a measurement object identifier applicable to the condition;
the configuration information further comprises second configuration information, and the second configuration information is configured to configure multiple sets of measurement parameters; or
wherein in response to determining that the height-based parameter selection condition is applicable to part of measurement reporting configurations, the height-based parameter selection condition comprises: a second association relationship between each condition of multiple height-based parameter selection conditions and a reporting configuration identifier applicable to the condition, or a third association relationship between each condition and a measurement identifier associated with a measurement reporting configuration of the condition;
the configuration information further comprises second configuration information, and the second configuration information is configured to configure multiple sets of measurement parameters.

18.-22. (canceled)

23. The method according to claim 16, wherein the configuration information comprises second configuration information, and the second configuration information is configured to configure the height-based parameter selection condition and the at least two sets of measurement parameters;
wherein the second configuration information comprises the at least two sets of measurement parameters and a correspondence between at least one set of measurement parameters and the height-based parameter selection condition;
wherein the height-based parameter selection condition comprises at least one of:
a height-based measurement event;
a configuration of the height-based measurement event;
a first identifier indicating the height-based measurement event;
a first measurement identifier associated with the height-based measurement event;
a report configuration identifier associated with the height-based measurement event;
at least one threshold value associated with the height-based parameter selection condition; or
an index corresponding to the height-based parameter selection condition.

24. (canceled)

25. The method according to claim 19, wherein the second configuration information comprises at least one of:
at least two fields, wherein the at least two fields are configured to configure the at least two sets of measurement parameters, and are comprised in one measurement reporting configuration or one measurement object configuration;
at least two second measurement identifiers, wherein the at least two second measurement identifiers are respectively associated with different reporting configurations of a same measurement object;
a first list, wherein the first list is configured to modify and/or add a configuration of at least one measurement parameter in a configuration of one measurement object; and
a second list, wherein the second list is configured to delete a configuration of at least one measurement parameter in a configuration of one measurement object;
wherein a configuration of each measurement parameter in the first list comprises a second identifier indicating a measurement parameter and corresponding configuration information, and a configuration of each measurement parameter in the second list comprises a second identifier indicating a measurement parameter.

26.-29. (canceled)

30. A communication device, comprising:
a transceiver;
one or more processors; and
a memory storing a computer-executable instruction;
wherein the one or more processors are connected to the transceiver and the memory respectively, and are configured to load and execute the computer-executable instruction to implement the measurement parameter configuration method according to claim 1.

31. A communication system, comprising a user equipment and a network device, wherein the user equipment is configured to: determine a parameter for measurement based on height information of the user equipment; and
the network device is configured to send configuration information to the user equipment, wherein the configuration information is configured to: configure a measurement parameter.

32. A non-transitory computer-readable storage medium, storing a computer program, wherein the computer-readable storage medium stores an executable instruction, and the executable instruction is loaded and executed by one or more processors to cause the one or more processors to perform the measurement parameter configuration method according to claim 1.
